(19) United States
(12) Patent Application Publication
(10) Pub. No.: US 2002/0048360 A1
(43) Pub. Date: Apr. 25, 2002

(54) System and methods for distributed telecommunication applications for the public switched telephone network and the public land mobile network

(76) Inventors: Rajan A. Zambre, Westford, MA (US); Mahesh B. Danke, Chelmsford, MA (US); Prithviraj Banerjee, North Chelmsford, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/827,499

(22) Filed: Apr. 6, 2001

Related U.S. Application Data
(60) Provisional application No. 60/230,072, filed on Sep. 5, 2000.

(51) Int. Cl. H04M 7/00

(52) U.S. Cl. 379/229; 379/221.08

(57) ABSTRACT

The functions of a Signaling System 7 (SS7) network node are divided among multiple nodes of an Internet Protocol (IP) network. An “A” node includes an SS7 application component, and a “P” node includes an SS7 transport component connected to the SS7 network. Each node also includes an IP transport component and an adapter for translating messages between IP and SS7 protocols. The A nodes and P nodes inter-operate via the IP network in a manner invisible to the SS7 network and the SS7 application component. Each adapter requests a connection to a counterpart adapter from a connectivity manager for each transaction. The connectivity manager, which may be centralized or distributed in the IP network, allocates adapters to transactions and informs requesting adapters of the allocations. For load sharing, the connectivity manager weights the adapters by their transaction processing capacities and allocates adapters in proportion to their respective weights.

### CROSS REFERENCE TO RELATED APPLICATIONS

This application claims priority under 35 U.S.C. § 119(e) of Provisional Patent Application No. 60/230,072, filed Sep. 5, 2000 and entitled System, Methods And Services For Hybrid Service Deployment Platform.

### STATEMENT REGARDING FEDERALLY SPONSORED RESEARCH OR DEVELOPMENT

None

### BACKGROUND OF THE INVENTION

The present invention is related to the field of telephone systems, and more particularly to the manner in which services are provided in out-of-band telephone signaling systems.

Modern telephone systems employ so-called “out-of-band signaling” to dynamically manage connections for telephone calls and various services that are available to users of the telephone system, where “out-of-band signaling” refers to the use of equipment and connections other than those used to carry telephone calls. For example, messages are exchanged by telephone switches over a signaling network in order to establish connection segments that collectively form an end-to-end voice connection for a call, where the signaling network is separate from the network of such voice connections. The signaling messages include information such as the originator and destination of the call, the identity of trunk lines or other circuits intended to carry the call, and status information such as whether a line is busy or an existing call has been terminated. Switching equipment and other equipment in the telephone network use the information in the messages to establish or tear down local segments of an end-to-end connection, for example, as well as for other purposes.

In North America, a signaling system known as Signaling System 7 or SS7 is used in conjunction with the public switched telephone network (PSTN). SS7 is a messaging network specially tailored for telephone signaling. It incorporates multi-layer functionality along the lines of the Open Systems Interconnect (OSI) model. At the highest layer, SS7 applications provide high-level functions such as call establishment and specialized services such as 800 service and repeat dialing. At the lowest layer, SS7 relies upon standard 64-kbit/s Digital Signal 0 (DS0) channels to carry messages among SS7 nodes. In between are additional layers providing intermediate network services such as link monitoring, message routing, error reporting, etc.

Additionally, an SS7 network employs different types of nodes having specialized functions. The three main node types are Signal Switching Points (SSPs), Signal Transfer Points (STPs), and Signal Control Points (SCPs). An example of an SSP is a central office switch equipped with SS7 capability. It can generate and respond to SS7 signaling messages in establishing connections to far-end equipment for a call. An STP is an intermediate node in the SS7 network used for two primary purposes. First, STPs serve as routing hubs for SS7 messages, such as messages being sent from one SSP to another SSP in the network. Also, STPs serve as access points for specialized services, which are provided by the SCPs. An STP may examine a received SS7 message, for example, and determine that 800 service has been invoked. In order to route the message toward the intended destination, the STP consults a database on an SCP to which the STP is connected. The SCP returns the identity of the actual destination in the network, and the STP uses this information to forward the SS7 message appropriately. Thus, SCPs act as “servers” for one or more services available in the network.

In addition to hardware and software for higher level functions such as call establishment, routing, etc., each node in an SS7 network requires one or more DS0 connections to neighboring SS7 nodes and one or more instances of an SS7 protocol stack in order to communicate with the other nodes in the SS7 network. These specialized lower-layer SS7 components contribute to the costs of the services provided via the SS7 network. Additionally, in order to add new services or expand existing services in an SS7 network, it may be necessary to upgrade and/or reconfigure significant portions of the SS7 network. The SS7 network has exhibited a monolithic characteristic with limited flexibility to deploy new or expanded services.

### BRIEF SUMMARY OF THE INVENTION

In accordance with the present invention, a hybrid system for deploying services in the public switched telephone network is disclosed that achieves greater cost effectiveness, flexibility, and in some cases performance than prior systems such as monolithic SS7 networks.

In the disclosed system, the functions of a node in a signaling network such as an SS7 network are divided across multiple nodes using a non-SS7 network such as an Internet Protocol (IP) network. An “A” node includes an application software component, which may have an existing interface to an SS7 transport component or protocol stack. A “P” node includes an SS7 transport component and a connection to the SS7 network. Each node also includes a transport component for the IP network, and an adapter for translating messages between the SS7 and IP networks. The A nodes and P nodes inter-operate with each other via the IP network in a manner invisible to both the SS7 network and the SS7 application component. SS7 applications can be added or expanded in a rapid and scalable fashion by adding A nodes to the IP network, without the need to add P nodes or re-configure the SS7 network.

The disclosed system includes a connectivity manager responsible for allocating resources such as a P adapter or A adapter to application transactions. The connectivity manager may be centralized on a distinct node in the IP network, for example, or it may be distributed among the A and P nodes. Each adapter communicates with the connectivity manager to request a counterpart adapter for the transaction. The connectivity manager incorporates a load sharing algorithm to distribute the transaction load among candidate adapters. According to one load sharing algorithm, various candidate adapters are weighted according to their respective transaction processing capacities, and the adapters are allocated to transactions in proportion to their respective weightings.

Other aspects, features, and advantages of the present invention are disclosed in the detailed description that follows.

### BRIEF DESCRIPTION OF THE SEVERAL VIEWS OF THE DRAWING

The invention will be more fully understood by reference to the following Detailed Description in conjunction with the Drawing, of which:

FIG. 1 is block diagram of a prior art telephone system employing Signaling System 7 (SS7) signaling;

FIG. 2 is a diagram illustrating communications among various hierarchical SS7 signaling components used in the telephone system of FIG. 1;

FIG. 3 is a block diagram of a hybrid service providing system in accordance with the present invention that is used in conjunction with an SS7 signaling system like that of FIGS. 1 and 2;

FIG. 4 is a block diagram illustrating the use of a centralized connectivity manager to manage communications links for service transactions in the system of FIG. 3;

FIG. 5 is a block diagram illustrating the use of a distributed connectivity manager to manage communications links for service transactions in the system of FIG. 3;

FIG. 6 is a block diagram of the connectivity manager of FIGS. 4 and 5;

FIG. 7 is a block diagram of a connectivity agent and related components used in conjunction with the connectivity manager of FIG. 6;

FIG. 8 is a diagram illustrating a transaction-based load sharing scheme employed in the system of FIG. 3;

FIGS. 9 and 10 are signaling diagrams showing transactions pertaining to load sharing of server applications in the system of FIG. 3; and

FIG. 11 is a flow diagram showing the operation of the connectivity manager of FIGS. 4 and 5.

### DETAILED DESCRIPTION OF THE INVENTION

The disclosure of Provisional Patent Application No. 60/230,072, filed Sep. 5, 2000 and entitled System, Methods And Services For Hybrid Service Deployment Platform is incorporated by reference herein.

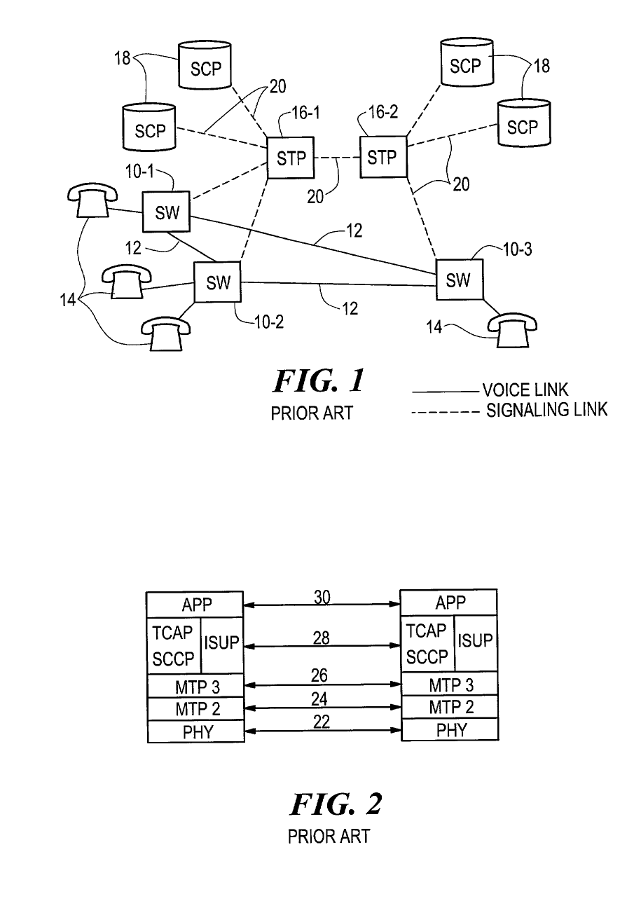

FIG. 1 shows a simplified example of a telephone system employing Signaling System 7 (SS7) out-of-band signaling. Switches 10-1, 10-2 and 10-3 are interconnected by voice trunks 12 which carry voice or data calls among various terminal devices 14, such as telephones, facsimile machines or data modems. Each voice trunk 12 includes a number of 64 Kb/s channels of the type referred to as “digital signal 0” (DS0) channels. Each switch 10 is operative to dynamically establish connections between the links to the terminal devices 14, on the one hand, and the channels of the voice trunks 12 in order to create end-to-end connections between terminal devices 14 participating in calls. Although in FIG. 1 the switches 10 are shown as being directly connected by the voice links 12 and the devices 14 are shown as being directly connected to the switches 10, in general there may be additional equipment such as intermediate switches, multiplexers, etc. interposed at various places in the network. Such additional components are omitted from FIG. 1 for the sake of clarity.

Also shown in FIG. 1 are SS7 signaling components including signaling transfer points (STPs) 16-1 and 16-2 and signaling control points (SCPs) 18, which are interconnected among themselves and with the switches 10 by signaling links 20. The signaling links 20 are also DS0 channels, but are generally established in a pre-arranged and relatively long-lived manner, in contrast to the dynamic, generally short-lived nature of the connections on the voice trunks 14. As a result, the switches 10, STPs 16, and SCPs 18 can freely and quickly exchange signaling messages over the signaling links 20 as needed to set up, tear down, and otherwise manage the voice connections on the voice trunks 12 and in the switches 10. The collection of STPs 16, SCPs 18, and signaling links 20 are generally referred to as the “SS7 network”.

One major function of the STPs 16 is to route signaling messages originating at one switch 10 to one or more destination switches 10. As an example, a call originating at a terminal 14 connected to switch 10-1 that is destined for a terminal 14 connected to switch 10-3 proceeds generally as follows:

1. Switch 10-1 sends a call origination message to STP 16-1 indicating that the call is destined for a terminal connected to switch 10-3. Also included is an identifier of a trunk 12 and a channel on the trunk 12 that switch 10-1 will use for the call if it is completed.

2. STP 16-1 determines that the message needs to be forwarded to STP 16-2 in order to reach switch 10-3, and forwards the message over the signaling link 20 between the two STPs 16.

3. STP 16-2 forwards the message to switch 10-3, which determines whether the destination terminal 14 can accept the call and engages in additional signaling with the originating switch 10-1 via the STPs 16-1 and 16-2 to complete the end-to-end connection.

The SCPs 18 perform operations pertaining to higher level services in the network. A common example is toll-free service involving telephone numbers having an 800 prefix. When an STP 16 receives a call origination message containing an 800 number, it has no area code with which to make an independent call routing decision. The SCPs 18 provide information to the STPs 16 that enables the STPs 16 to correctly route the call. Generally, there are a wide variety of services enabled by the SCPs 18 in conjunction with the STPs 16.

FIG. 2 shows the multi-layer characteristic of the SS7 network. Peer-to-peer communications occur at a physical (PHY) layer 22, a message transfer part 2 (MTP2) layer 24, a message transfer part 3 (MTP3) layer 26, and a multi-function layer 28 that provides various services to software applications at an application layer 30. The PHY layer 22 is typically a DS0 channel. The MPT2 layer 24 provides link-layer functions such as error checking and message sequencing. The MTP3 layer 26 provides network-layer functions such as message routing. The multi-function layer 28 generally includes two sets of protocols and services known as ISDN user part (ISUP) and transaction capabilities part (TCAP). ISUP is used in the establishment and tearing down of voice and data calls and the management of the trunks 12 (FIG. 1). TCAP defines messages and protocol used to communicate between application entities deployed in different nodes. For example, TCAP is used by applications that provide calling card and 800 services, as well as switch-to-switch services such as repeat dialing and call return. As shown, TCAP generally relies upon services provided by a signaling connection control part (SCCP).

As shown in FIG. 2, components at all of the SS7 layers 22-30 (which are collectively referred to as an “SS7 stack”) are generally needed at each SS7 node such as the STPs 16 and SCPs 18. In particular, it is generally necessary that there be one or more DS0s configured between each pair of SS7 nodes that wish to communicate. The need for configured DS0s and a complete SS7 stack at each node may be undesirable constraints in some circumstances, such as when new services are to be offered or existing services expanded. Flexibility in deploying applications may be limited, and the costs for equipment, software and services may be undesirably high.

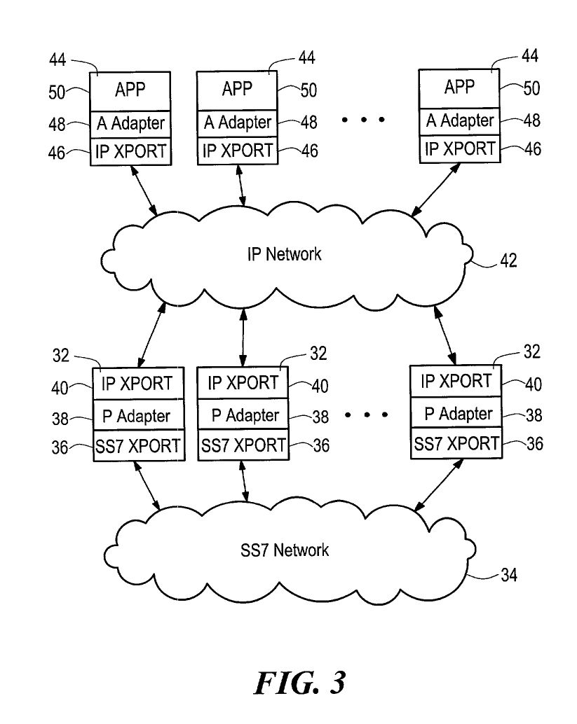

FIG. 3 shows a signaling system that is a hybrid of SS7 components and non-SS7 components. This hybrid system can generally realize greater flexibility, scalability, and cost effectiveness than prior systems, while retaining a large degree of backwards compatibility with existing SS7 equipment and applications. In FIG. 3, several nodes referred to as “P nodes” 32 are connected to an SS7 network 34. Each P node 32 includes an SS7 transport component 36, a P adapter component 38, and an Internet Protocol (IP) transport component 40. The SS7 transport component 36 includes functions at the SS7 physical layer 22, MTP2 layer 24, and MTP3 layer 26 (FIG. 2), while the IP transport component 40 generally includes a transport-layer component such as TCP or UDP in addition to network-layer IP functionality. The IP transport component 40 connects to an IP network 42, such as the Internet, via standard link-layer and physical-layer components (not shown) such as Ethernet components.

Also connected to the IP network 42 are nodes referred to as “A nodes” 44, each including an IP transport component 46, an A adapter component 48, and one or more application components 50. The IP transport component 46 is generally similar or identical to the IP transport component 40 used in the P nodes 32. The other components are described below.

In the network of FIG. 3, SS7 applications can be deployed more independently of the SS7 network connection points than in traditional SS7 networks. This is achieved by splitting the functionality of the multi-function layer 28 of FIG. 2, such as TCAP and ISUP functions, into an A adapter 48 and P adapter 38 connected to each other via the IP network 42. The application components 50 are no longer constrained to co-reside with the equipment connected to the SS7 network 34; rather, they can be configured on generic computer equipment with suitable interfaces to the IP network 42. There can be much richer sharing of applications and SS7 connections.

The primary task of the P nodes 32 is to provide access to the SS7 network 34 on behalf of the A nodes 44, on which the applications reside. Each P adapter 38 serves as a “proxy” for the remotely located A adapters 48 that are associated with specific application components 50. Thus, the collection of a TCAP P adapter 38, a TCAP A adapter 48, and the IP transport link therebetween function as a “virtual TCAP” component, for example. Similarly, the collection of an ISUP P adapter 38, an ISUP A adapter 48, and the IP transport link therebetween function as a “virtual ISUP” component.

In particular, the P adapters 38 interface with the SS7 transport components 36 and distribute SS7 messages to and from the remote A adapters 48 via the IP network 42. A single P adapter component 38 may be associated with one or more physical SS7 network interfaces in the P node 32 in which the P adapter 38 resides. Also, there are different types of P adapters 38 for different protocol variants, such as TCAP, ISUP, etc.

The A adapters 48 primarily translate IP messages to corresponding SS7 messages as understood by the application components 50. Here also there are different types of adapters for different protocol variants. Thus, there is a TCAP A adapter 48, an ISUP A adapter 48, etc.

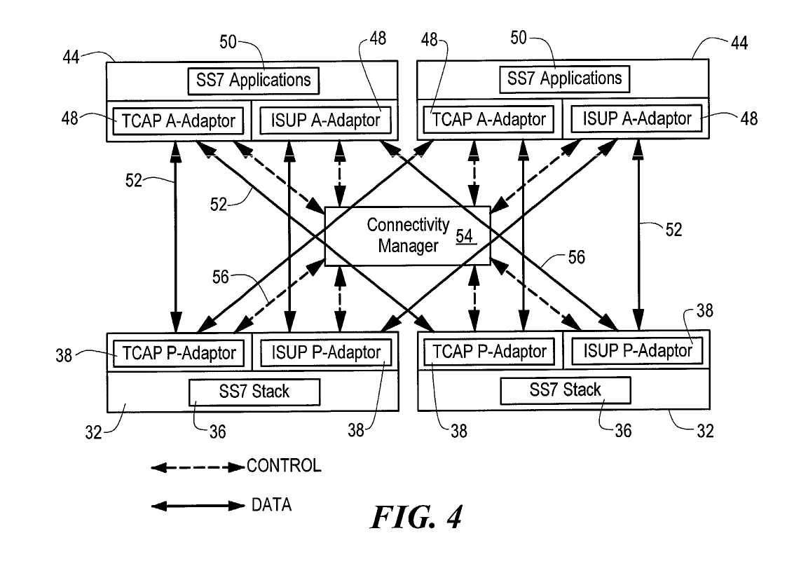

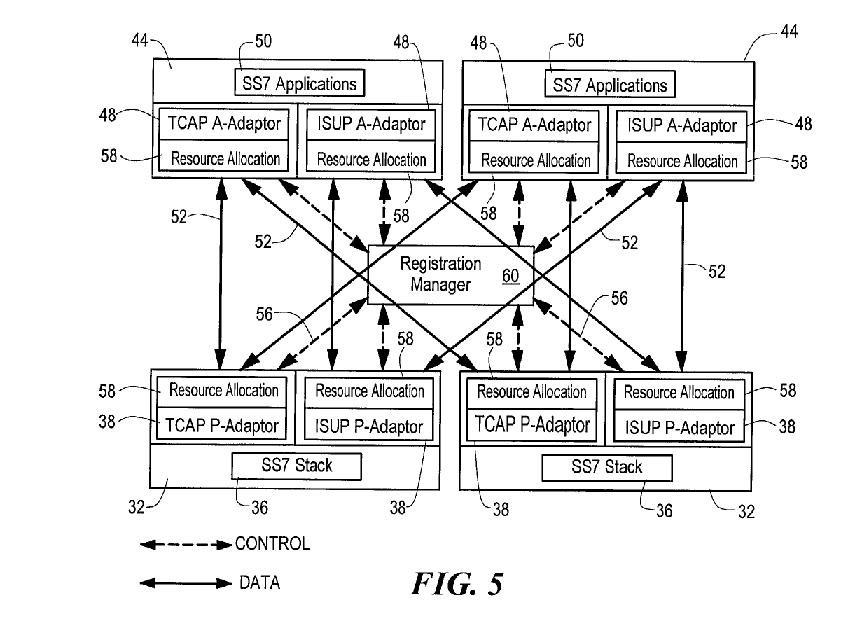

FIGS. 4 and 5 show transport connections that are established in the IP network 42 to enable signaling transactions to be carried out among the A adapters 48 and P adapters 38. As shown, data connections 52 are created between each P adapter 38 and A adapter 48 of the same type, i.e., between each TCAP P adapter 38 and each TCAP A adapter 48, etc. These connections are established, torn down, and otherwise managed by a connectivity manager, which is shown as a centralized connectivity manager 54 in FIG. 4. Control connections 56 carry signaling messages between the connectivity manager 54 and the various adapters 38 and 48 for establishing the data connections 52. The centralized connectivity manager 54 may reside on a separate node (not shown) in the IP network 42 (FIG. 3). FIG. 5 shows how the connectivity manager can be “distributed” as separate resource allocation components 58 residing within the P nodes 32 and A nodes 44 themselves. When a distributed connectivity manager is employed, the P nodes 32 and A nodes 44 are registered at a central registration manager 60, but otherwise perform the connectivity management functions in a distributed manner among themselves.

Whether centralized or distributed, the connectivity manager performs a number of functions, including provisioning or configuring the various adapters 38 and 48 and allocating resources for transactions. An adapter 38 or 48 initiates a transaction by querying the connectivity manager through a control channel 56. The connectivity manager responds by allocating a counterpart adapter (such as P adapter 38 for a transaction initiated by an A adapter 48 and vice-versa) and a data connection 52 for the transaction. Upon completion of the transaction, the initiating adapter notifies the connectivity manager to enable the resources to be de-allocated, thereby becoming available for allocation to subsequent transactions.

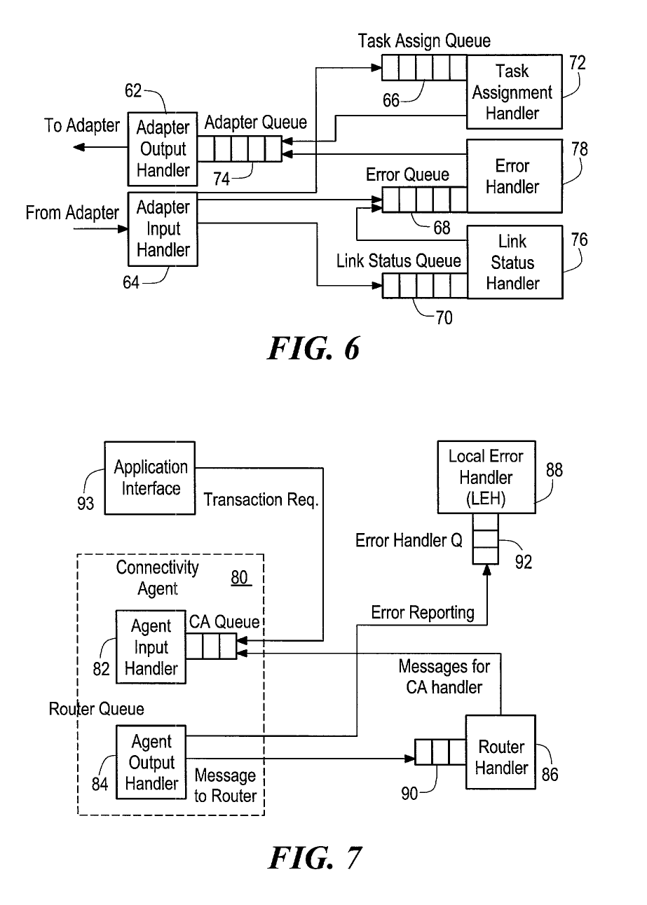

FIG. 6 shows the structure of the connectivity manager. For each adapter 38 and 48 to which the connectivity manager connects, there is a corresponding output handler 62 and output handler 64. Messages received from an adapter 38 or 48 are initially processed by the associated input handler 64 and then provided to either a task assignment queue 66, an error queue 68, or a link status queue 70, as dictated by the message contents. A task assignment handler 72 is responsible for receiving transaction requests, allocating resources, and communicating with transaction participants to enable the transaction to proceed. Messages generated by the task assignment handler 72 that are intended for an adapter 38 or 48 are placed in an adapter queue 74 for the adapter output handler 62 associated with the destination adapter. A link status handler 76 is responsible for detecting problems in establishing or maintaining connections, and along with the adapter input handler 64 deposits messages in the error queue 68. An error handler 78 performs error reporting and, when possible, error recovery procedures, which in some cases includes generating messages and placing them in the appropriate adapter queue 74 for delivery to an adapter 38 or 48.

FIG. 7 shows the structure of a connectivity agent 80 and associated components, which reside in each adapter 38 and 48. An agent input handler 82 and agent output handler 84 process messages exchanged with the connectivity manager. Received messages are provided to either a router handler 86 or local error handler 88 via respective queues 90 and 92. The router handler 86 routes messages among the adapters 38 and 48, using a dynamic routing table (not shown) having current connection information. The local error handler 88 receives error messages from the adapter error handler 78 and takes appropriate action in response, such as closing the affected transaction, notifying the affected application, logging the error, and initiating error recovery.

The centralized connectivity manager 54 of FIG. 5 allocates resources to transactions according to a suitable load-sharing algorithm. One such algorithm is based on defining a “watermark” for each adapter 38 and 48 that represents the maximum number of simultaneous transactions the adapter 38 or 48 can handle in a given interval. When a transaction is initiated, the connectivity manager 54 determines which of the candidate target adapters for the transaction is most lightly loaded, and allocates this adapter to the transaction. For each adapter, the measure of loading is the ratio of active transactions being handled by the adapter to the watermark. Other load-sharing algorithms can also be employed. For example, the adapter that has been assigned a new transaction least recently can be chosen, subject to the watermark limit.

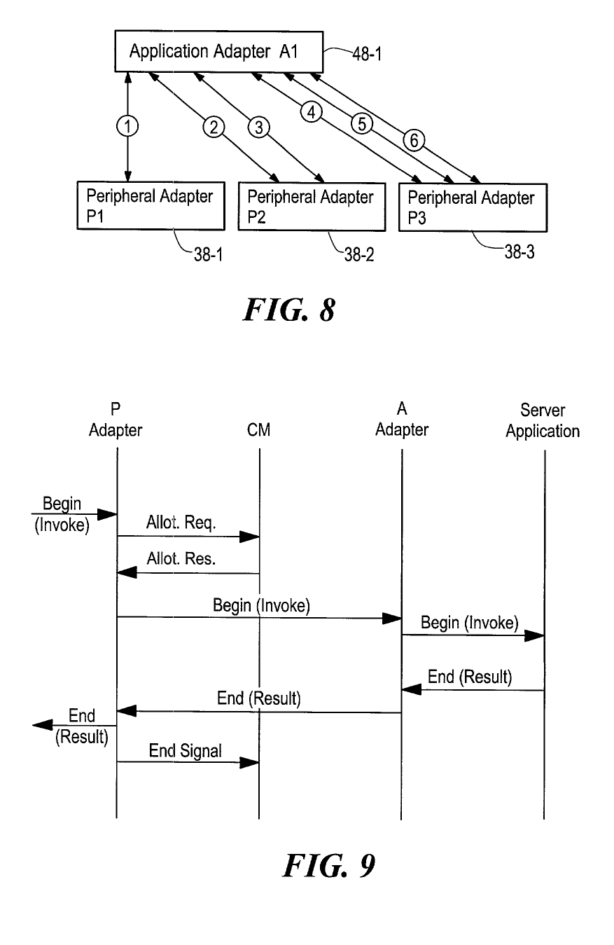

FIG. 8 illustrates a technique of resource allocation in the case of a distributed connectivity manager. In this case, each adapter that initiates transactions is responsible for choosing from among candidate target adapters in a fair manner based on certain criteria. One useful criteria is the relative processing capacity of the candidate targets. In the example of FIG. 8, an A adapter 48-1 is configured with information indicating that P adapter 38-1 has a processing capacity of 1 unit (e.g. 100 transactions per second or TPS), P adapter 38-2 has a processing capacity of 2 units (e.g. 200 TPS), and P adapter 38-3 has a processing capacity of 3 units (e.g. 300 TPS). Generally, the A adapter 48-1 simply selects the P adapters 38 in a round robin fashion for successive transactions. However, this algorithm is modified to account for the relative processing capacities of the P adapters 38. Thus, out of every six transactions initiated by A adapter 48-1, one is assigned to P adapter 38-1, two are assigned to P adapter 38-2, and three are assigned to P adapter 38-3. Using this approach, the transaction load is shared in a desirably even fashion.

FIG. 9 illustrates messaging involved in allocating and using a TCAP application component 50 for a transaction. A P adapter 38 receives a Begin message invoking the TCAP service from a client node in the SS7 network 34. The P adapter 38 in turn sends an Allotment Request message to the connectivity manager (CM). The connectivity manager allocates an A adapter 48 to the transaction as described above, and returns an Allotment Response message to the P adapter 38 identifying the allocated A adapter 48. The P adapter 38 then sends a Begin message to the allocated A adapter 48 over the IP network 42. This message corresponds to and carries the same information as the received SS7 Begin message received from the SS7 client, but it is formatted as an IP packet for delivery by the IP transport component 40 of the P node 32 (FIG. 3). The A adapter 48 responds to the receipt of this IP Begin message by creating a corresponding SS7 Begin message (which is similar or identical to the original message received by the P adapter 38) and invoking the TCAP server application. At this point, there can be many transactions (not shown) that occur between the client and the server application. Examples include the ITU-T messages Continue(Invoke/ReturnResult) and ANSI Conversation (With or Without Permission).

Upon completion of the transaction, the server application generates an End message which is received by the A adapter 48. The A adapter 48 re-formats this message to an IP format, and the IP transport component 46 forwards the message over the IP network 42 to the participating P adapter 38. The message is then re-formatted into an SS7 message and forwarded to the requesting client in the SS7 network 34. The P adapter 38 also provides an End signal to the connectivity manager to release the resources allocated to the transaction.

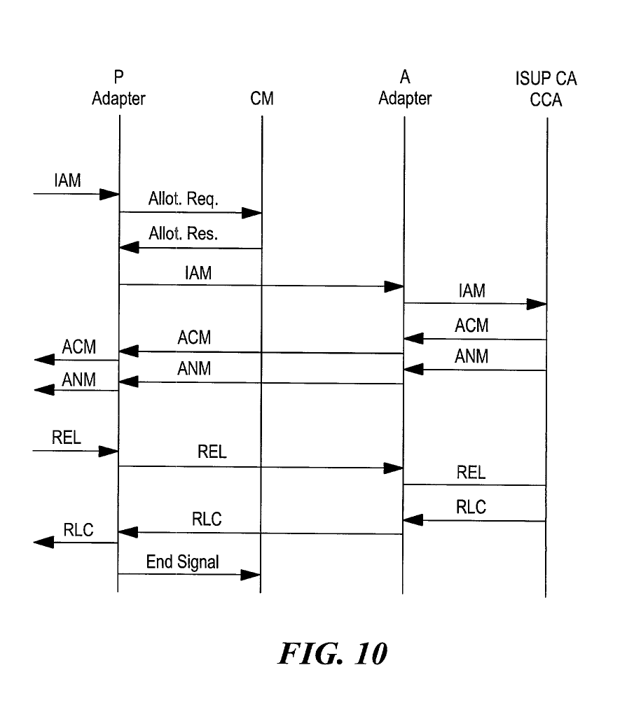

FIG. 10 illustrates messaging involved in allocating and using an ISUP application component 50 for a transaction. An Initial Address Message (IAM) received at a P adapter 38 results in an Allotment Request to the connectivity manager and a subsequent Allotment Response identifying an A adapter 48 allocated to the transaction. An IP version of the IAM is then forwarded to the allocated A adapter 48, where it is re-formatted to an SS7 version and provided to an ISUP application component 50. Subsequently, the ISUP application component 50 generates an Address Complete Message (ACM), which is formatted by the A adapter 48 and sent back to the originating P adapter 38. This message is re-formatted back to the SS7 format and forwarded to the SS7 client. This same procedure is also followed for a subsequent Answer Message (ANM).

At some point, one party terminates the call and generates a Release Message (REL), which is sent to the other participant via the P node 32 and A node 44 with IP and SS7 re-formatting as described above. The other end responds with a Release Complete (RLC) message. The P adapter 38 sends the RLC message to the SS7 client and sends an End signal to the connectivity manager to release the resources allocated to the transaction.

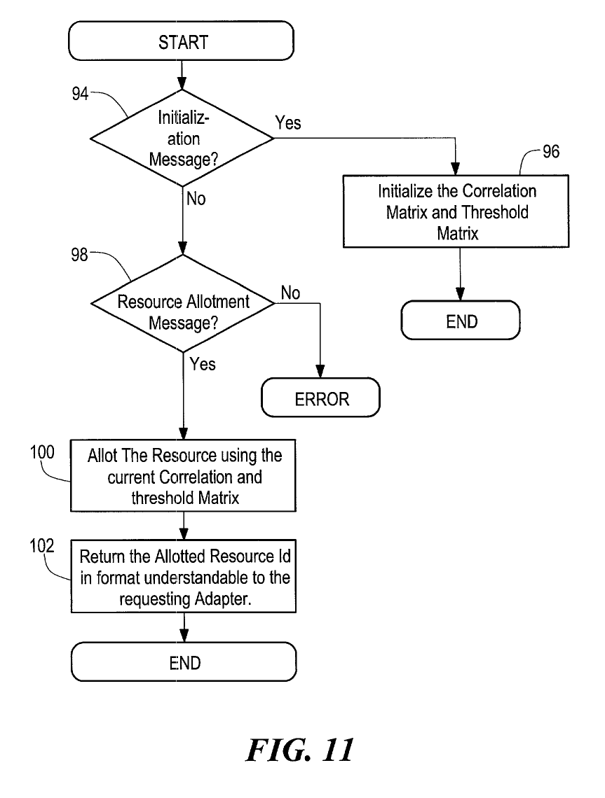

FIG. 11 shows a flow diagram of the operation of the connectivity manager. At step 94, it is determined whether an initialization message has been received. This message is received by the connectivity manager and originated by the adapters, which send the message to a configured address. If an initialization message has been received, then at step 96 a pair of matrices known as the “correlation matrix” and “threshold matrix” are initialized. The correlation matrix includes connection rules for the A/P adapters 38 and 48. As an example, a Hosting MAP application may require that a TCAP P adapter 38 be configured to connect to only a specific A Adapter 48. Generally, all ISUP P adapters 38 can connect to all ISUP A adapters 48, and all TCAP P adapters 38 can connect to all TCAP A adapters 48. These connections are established using data from the correlation matrix.

The threshold matrix provides the current connectivity status between A adapters 48 and P adapters 38. It also provides the information regarding the maximum number of transactions supported (“threshold”) by the adapters, due to various factors such as system performance or the architecture of the application.

As an example of a threshold matrix, if an A adapter A1 has 8 open transactions and its threshold is 10, then the threshold matrix entries for a hypothetical case of 3 P adapters with 2,3,3 transactions are as follows (where PA/TH identifies a P adapter and its threshold, and AA/TH identifies an A adapter and its threshold):

| | AA/ | (A1) | A2 | A3 |
|---|---|---|---|---|
| PA/TH | TH | (10) | 10 | 100 |
| P1 100 | | (2) | 8 | 45 |
| P2 100 | | (2) | 8 | 45 |
| P3 200 | | (4) | 8 | 10 |

In no case should the total number of open transactions exceed the threshold value.

Different allocation algorithms can be used. Round robin allocation may be desirable. Alternatively, it may be desirable to use a threshold-weighted allocation using the above matrix and more fully specified as follows:

P3=2*P1

=2*P2

As Th (P3)=2*Th(P1)

=2*Th(P2)

This algorithm is described as “Transaction Based Load Sharing”.

At step 98 of FIG. 11, it is determined whether an Allotment Request message has been received. If so, a far-side adapter is allocated to the transaction at step 100 using the correlation and threshold matrices. If the request cannot be fulfilled, the connectivity manager sends an appropriate message to the far-side adapter. Then at step 102, an Allotment Response identifying the allocated adapter is returned to the requesting adapter.

Methods and apparatus for distributed telecommunication applications for the public switched telephone network and the public land mobile network have been shown. It will be apparent to those skilled in the art that modifications to and variations of the disclosed methods and apparatus are possible without departing from the inventive concepts disclosed herein, and therefore the invention should not be viewed as limited except to the full scope and spirit of the appended claims.

What is claimed is:

1. A system for providing services to a telephone signaling network, comprising:
a network node of a first type, the first-type network node including (i) a first network interface to the telephone signaling network, (ii) a second network interface to a second network, and (iii) an adapter, the adapter being operative to receive messages having a first format from the first network interface, the received messages including transaction-initiating messages, the adapter being further operative to translate the first-format messages into messages having a second format suitable for transmission over the second network and to provide the translated messages to the second network interface for transmission over the second network, the adapter also being operative to receive second-format messages from the second network interface, the received messages including transaction-terminating messages, and the adapter being further operative to translate the second-format messages into first-format messages and to provide the translated messages to the first network interface for transmission over the telephone signaling network; and
a network node of a second type, the second-type network node including (i) a network interface to the second network, (ii) a telephone service application, and (iii) an adapter, the adapter being operative to receive the second-format messages from the first-type network node via the network interface, translate the second-format messages into first-format messages, and provide the translated messages to the telephone service application, the adapter being further operative to receive first-format messages from the telephone service application, translate the first-format messages into second-format messages, and provide the translated messages to the network interface for transmission over the second network to the first-type network node.

2. A system according to claim 1, wherein the transaction-initiating messages include initial address messages initiating respective calls in a telephone network for which the telephone signaling network performs signaling, and the transaction-terminating messages include release messages indicating the termination of the respective calls.

3. A system according to claim 1, wherein (i) the telephone service application in the second-type network node is a first instance of the telephone service application, and (ii) the adapter in the first-type network node is operative in response to the receipt of each transaction-initiating message to generate an allotment request and to receive a corresponding allotment response prior to providing the translated transaction-initiating message to the second network interface, each allotment request requesting allocation of an instance of the telephone service application for a corresponding transaction and each allotment response identifying an instance of the telephone service application allocated to the corresponding transaction, and further comprising:
one or more additional second-type network nodes, each additional second-type network node being coupled to the second network and including an additional instance of the telephone service application; and
a connectivity manager, the connectivity manager being operative to (i) receive the allotment requests from the adapter in the first-type node, and (ii) for each allotment request, allocate one of the instances of the telephone service application to the corresponding transaction and return a corresponding allotment response identifying the instance of the telephone service application allocated to the transaction.

4. A system according to claim 3, wherein (i) the transaction-initiating messages include initial address messages initiating respective calls in a telephone network for which the telephone signaling network performs signaling, (ii) the transaction-terminating messages include release complete messages indicating the termination of the respective calls, (iii) the adapter in the first-type network node is operative in response to the receipt of each release complete message to provide an end signal to the connectivity manager, and (iv) the connectivity manager is operative in response to each end signal to de-allocate the instance of the telephone service application allocated to the terminated call.

5. A system according to claim 3, wherein the connectivity manager is operative to allocate the instances of the telephone service application to respective transactions according to a load-sharing algorithm.

6. A system according to claim 5, wherein the load-sharing algorithm includes weighting each instance of the telephone service application according to its transaction processing capacity, and allocating each instance of the telephone service application to transactions at a rate proportional to its weighting.

7. A system according to claim 5, wherein the load-sharing algorithm includes allocating different instances of the telephone service application to transactions in a round-robin fashion.

8. A system according to claim 7, wherein the load-sharing algorithm further includes weighting each instance of the telephone service application according to its transaction processing capacity, and allocating each instance of the telephone service application to transactions at a rate proportional to its weighting.

9. A system according to claim 3, wherein the connectivity manager is a centralized connectivity manager.

10. A system according to claim 3, wherein the connectivity manager is a distributed connectivity manager.
